(19) United States
(12) Patent Application Publication
(10) Pub. No.: US 2013/0060912 A1
(43) Pub. Date: Mar. 7, 2013

(54) Streaming-Content Analytics

(71) Applicants: David Kallett Rensin, Gainesville, VA (US); Brian J. Geoghegan, Vienna, VA (US); Richard E. Grenfell, Herndon, VA (US); Sean O'Brien, Chantilly, VA (US); Sean C. Osborne, Vienna, VA (US); Kevin J. Winters, Alexandria, VA (US); Adam Wise, Potomac, MD (US)

(72) Inventors: David Kallett Rensin, Gainesville, VA (US); Brian J. Geoghegan, Vienna, VA (US); Richard E. Grenfell, Herndon, VA (US); Sean O'Brien, Chantilly, VA (US); Sean C. Osborne, Vienna, VA (US); Kevin J. Winters, Alexandria, VA (US); Adam Wise, Potomac, MD (US)

(73) Assignee: REALITY MOBILE LLC, Herndon, VA (US)

(21) Appl. No.: 13/606,902

(22) Filed: Sep. 7, 2012

Related U.S. Application Data
(60) Provisional application No. 61/532,017, filed on Sep. 7, 2011.

(51) Int. Cl. G06F 15/16

(52) U.S. Cl. 709/219; 709/203

(57) ABSTRACT

In one embodiment, a method includes accessing data associated with one or more source logs. The data associated with the source logs corresponds to activity of a user at a particular time. The method also includes identifying the user and a device associated with the source logs; and mapping at least a portion of the data associated with the source logs to a user session associated with the user and the device. The user session corresponds to activity of the user while using the device. The information also includes providing data corresponding to a particular period of time based on the user session. The data corresponds to the particular period of time includes streaming content and geographic data captured during the particular period of time.

### RELATED APPLICATIONS

This application claims the benefit, under 35 U.S.C. §119(e), of U.S. Provisional Patent Application No. 61/532,017, filed 07 Sep. 2011 and entitled Example Analytics Tour Mode, which is incorporated herein by reference for all purposes.

This application is also related to, and incorporates herein by reference, U.S. patent application Ser. No. 13/243,680, filed on 23 Sep. 2011 and entitled “Distribution and Management of Streamable Data,” which claims priority to U.S. Provisional Patent Application No. 61/386,382, filed on 24 Sep. 2010.

### TECHNICAL FIELD

This disclosure generally relates to mobile devices.

### BACKGROUND

A mobile computing device—such as a smartphone, tablet computer, or laptop computer—may include components and/or functionality for determining its location, direction, or orientation, such as by GPS receiver, compass, or gyroscope. Such a device may also include components and/or functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, speakers, or other input/output elements. Mobile computing devices may also execute software applications to support the above-described components and/or functionality. With networking and/or communications applications, users may connect, communicate, and share information with other users.

### SUMMARY OF PARTICULAR EMBODIMENTS

Particular embodiments access data associated with a position log, where the data associated with the position log may correspond to activity of a user at a particular time. For example, the data may include streaming content and geographic data. In particular embodiments, the user and a device associated with the position log is identified. and mapping at least a portion of the data associated with the position log to a user session associated with the user and the device. The user session corresponds to activity of the user while using the device. The information also includes providing data corresponding to a particular period of time based on the user session. The data corresponds to the particular period of time and includes streaming content and geographic data captured during the particular period of time.

### BRIEF DESCRIPTION OF THE DRAWINGS

FIG. 1 illustrates an example network environment associated with streamable content analytics.

FIG. 2 illustrates an example session hierarchy.

FIG. 3 illustrates an example database schema for a session hierarchy.

FIG. 4 illustrates an example method for presenting data corresponding to a particular period of time.

FIG. 5A illustrates an example analytic search page.

FIG. 5B illustrates an example display of user session in an example search page.

FIG. 5C illustrates an example attributes panel in an example search page.

FIG. 5D illustrates an example analytic visual search page.

FIG. 6 illustrates an example analytic video player.

FIG. 7 illustrates example computing system.

### DESCRIPTION OF EXAMPLE EMBODIMENTS

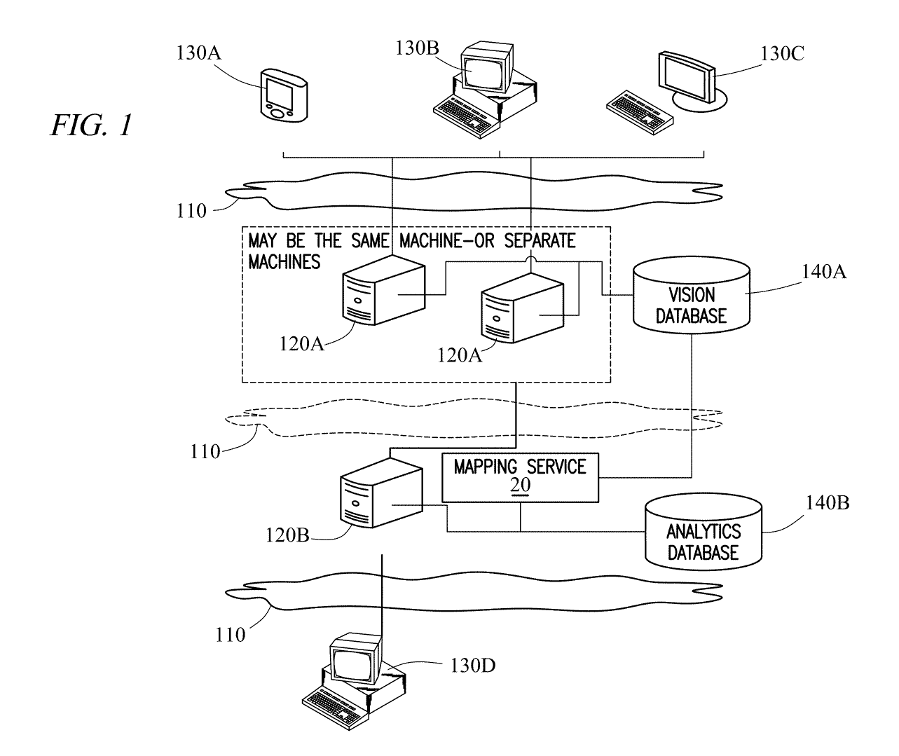

FIG. 1 illustrates an example network environment associated with streamable content analytics. In the example of FIG. 1, client devices 130A-C communicate with other components of example system 100 through a network 110. In particular embodiments, network 110 may be a wired network such as for example a local area network (LAN), a wireless network or a combination of one or more types of wireless networks. As an example and not by way of limitation, network 110 may be a cellular network, such as for example global system for mobile communications/general packet radio services (GSM/GPRS), code division multiple access/1 times radio transmission technology (CDMA/1×RTT), any next-generation data services such as for example 3rd generation (3G) services that may include EDGE, UMTS, HSDPA, EVDO and WCDMA, or any combination of wired and wireless networks. As another example, network 110 may include other types of wireless networks, such as for example a wireless local area network (WLAN), such as for example a WI-FI network, a private cellular network, such as for example a picocell-type base station configuration. A private cellular network may be useful in circumstances when the commercial cellular networks are temporarily unavailable. Additionally, network 110 may be a satellite-based wireless system. In particular embodiments, network 110 may comprise an intranet, an extranet, a virtual private network (VPN), a local area network (LAN), a wireless LAN (WLAN), a wide area network (WAN), a metropolitan area network (MAN), a portion of the Internet, a cellular technology-based network, a satellite communications technology-based network, or another network 110 or a combination of two or more such networks 110. This disclosure contemplates any suitable network 110.

As an example and not by way of limitation, client devices 130A-C may comprise a computer system such as: a desktop computer, a notebook or laptop, a netbook, a tablet, an e-book reader, a global positioning system (GPS) device, a camera, a personal digital assistant (PDA), a handheld electronic device, a mobile telephone, or another similar processor-based electronic device. In particular embodiments, client devices 130A-C may include a mobile client device 130A, a desktop client device 130B, a fixed or mobile computing platforms 130C, or any combination thereof. In particular embodiments, client devices 130A-C may include a digital camera, camcorder, webcam or any comparable device configured to capture live images, transmit the images to one or more servers 120A or “vision” servers. As an example and not by way of limitation, a mobile client device 130A with an embedded camera, such as for example a camera-equipped mobile phone may be configured to capture a still image or a short video clip on the device, save the images as a data file and transfer the images through an email-type transfer via a wired or wireless connection to one or more cellular numbers or email addresses. Moreover, mobile client device 130A may also generate and transmit an accompanying text message or capture and transmit an audio recording to one or more servers 120A. In particular embodiments, data from client devices 130A-C may be transmitted to one or more servers 120A. As an example and not way of limitation, one server 120A may be configured to receive and process video data and another server 120A may be configured In particular embodiments, an application executed on one or more client devices 130A-C may stream content, such as live video or audio data to one or more servers 120A. In particular embodiments, a single server 120A may receive and process the data from client devices 130A-C. In particular embodiments, an image service executed on server 120A may receive and process the live imagery (e.g., streaming video data) transmitted from mobile client device 130A, a desktop client device 130B, or other sources.

Location information and other applicable data, such as sensor data (e.g. temperature, radiation levels, etc.) may be transmitted with streaming content, such as for example video or audio data to client 130A. In particular embodiments, client devices 130A-C may have an internal GPS receiver or may be communicatively coupled to an external GPS receiver through a connection such as for example a universal serial bus (USB) connection or a BLUETOOTH wireless connection. Server 120A may receive images captured by client devices 130A-C with other designated data captured by client devices 130A-C such as for example audio files, sensor data, etc. and transcode them into an applicable file format. As an example and not by way of limitation, the data transmitted from client devices 130A-C to server 120A may be processed or recorded in one or more position logs stored in database 140A or “vision” database, as described below. In particular embodiments, data transmitted by client devices 130A-B are processed by server 120A and stored in log files that capture moments in time and server 120A may transmit the current status of client devices 130A-B to client device 130C or other systems through an application programming interface (API) of server 120A.

As described below, mapping service 150 may convert the data stored in the one or more logs stored in “vision” database 140A into a “session” format stored in “analytics” database 140B. Mapping service 20 may communicate with the “vision” database 140A and “analytics” database 140B through network 110. In particular embodiments, mapping service 20 runs as a service executed on server 120B. As an example and not way of limitation, mapping service 20 may be a WINDOWS COMMUNICATION FOUNDATION (WCF) service running under Internet information services (IIS), or as a WINDOWS service running within server's 120B service processes, or any combination thereof. In particular embodiments, the connection to database 140A is performed through a data access layer used by the server 120A.

As described below, server 120B may search for and view archived streaming content previously captured by client devices 130A-C and stored in position logs on database 140A. In particular embodiments, client device 130D may establish a connection to server 120B through network 110 to process requests to view archived streaming content stored in database 120A. In particular embodiments, an application on server 120B may provide access to the archive of activity information captured by server 120A. As an example and not by way of limitation, a user has the ability to access information associated with what client devices 130A-B were doing at a particular period of time.

In particular embodiments, the process of mapping data from logs stored in database 140A to sessions stored in database 140B, e.g., by a consumption engine, may be initiated manually, as a scheduled job, in real-time, or any combination thereof. In particular embodiments, the mapping process may be performed when server 120A is run in a closed network 110 that is manually connected to the network 110 as server 120B. As an example and not by way of limitation, a server 120A connected to a pico-cell mesh network that is designed to be transported in a vehicle. In particular embodiments, the mapping process may be initiated as periodically scheduled job that is run through server 120B scheduling services. As an example and not by way of limitation, the mapping process may be scheduled during periods of low activity on server 120A. In particular embodiments, the mapping process may be run as a real-time process. As an example and not by way of limitation, the mapping process may be activated in response to new status data being received through a structured query language (SQL) server trigger.

In particular embodiments, mapping service 20 fetches each user record stored in database 140A and determines whether a record exists for each user in database 140B. In particular embodiments, mapping service 20 determines whether a record exists in database 140B for each device and the associated capabilities. Mapping service 20 may synchronize session data in response to determining a record exists for each user and device in database 140B. In particular embodiments, a session manager of mapping service 20 organizes a flow of data through mapping service 20 to access the data in database 140A and create, update, close and write out sessions to database 140B. Moreover, the session manager provides a central in-memory repository for all currently “open” user sessions.

In particular embodiments, as the mapping process runs, it accesses the position log records stored on database 140A. In particular embodiments, each record in database 120A is accessed and examined for the user and device associated with a status change. In particular embodiments, the user and device combination may be unique to a given user session. In particular embodiments, the user session may cover a given user for all devices on which the user is concurrently logged in. In particular embodiments, if an open user session in database 140B is found, the record is passed in for processing. In particular embodiments, if there is not an open user session or the new record has a sign-on event type, a new user session is created using the new record to initialize it. Any open user session is first closed and then saved to the database 140B before the new session is created in response to accessing a sign-on record.

In particular embodiments, the mapping process finalizes open sessions once a mapping process is completed. This may occur while some sessions are still open. The open sessions may be stored in database 140B and are marked as being open. This indicates to mapping service 20 that these sessions are not fully completed, but the data that is available can still be searched by server 120A and displayed by client device 130D, or to be updated and possibly seen as completed and closed on a future mapping process.

In particular embodiments, during the mapping process, it is possible for a sign-on event to be received without the sign-off event from a prior user session being received first. When this occurs it creates what infers as a “soft” stop time. Such a time value informs mapping service 20 that a sign-off time may not be exact. During that period of time a sign-off request by client device 130A-B may not be received. Since there is this gap in time (in which other actions may have taken place, in other user sessions, that the user may or may not have been able to be aware of this state is marked and recorded in the user sessions for inspection and consideration when browsing the recorded data.

Servers 120 may be of various types, such as, for example and without limitation, web server, news server, mail server, message server, advertising server, file server, application server, exchange server, database server, proxy server, another server suitable for performing functions and/or processes described herein, or any combination thereof. In particular embodiments, each server 120 may include hardware, software, or embedded logic components or a combination of two or more such components for carrying out the appropriate functionalities implemented or supported by server 120. For example, a web server is generally capable of hosting websites containing web pages or particular elements of web pages. More specifically, a web server may host hypertext markup language (HTML) files or other file types, or may dynamically create or constitute files upon a request, and communicate them to clients 130 in response to hypertext transfer protocol (HTTP) or other requests from clients 130. A mail server is generally capable of providing electronic mail services to various clients 130. A database server is generally capable of providing an interface for managing data stored in one or more data stores. In particular embodiments, an application server may be hosted on a server 120. In particular embodiments, each server 120 may be a unitary server or a distributed server spanning multiple computers or multiple datacenters. Although this disclosure describes and illustrates a particular system having a particular configuration of particular components, this disclosure contemplates a system having any suitable configuration of any suitable components.

In particular embodiments, a client 130 may be an electronic device including hardware, software, or embedded logic components or a combination of two or more such components and capable of carrying out the appropriate functionalities implemented or supported by client 130. For example and without limitation, a client 130 may comprise a computer system such as: a desktop computer, a notebook or laptop, a netbook, a tablet, an e-book reader, a global positioning system (GPS) device, a camera, a personal digital assistant (PDA), a handheld electronic device, a mobile telephone, or another similar processor-based electronic device. This disclosure contemplates any suitable clients 130. A client 130 may enable a network user at client 130 to access network 110. A client 130 may enable its user to communicate with other users at other clients 130.

A client 130 may include browser software, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 130 may enter a Uniform Resource Locator (URL) or other address directing the browser to a server 120, and the browser may generate a HTTP request and communicate the HTTP request to server 120. Server 120 may accept the HTTP request and communicate to client 130 one or more HTML files responsive to the HTTP request. Client 130 may render a web page based on the HTML files from server 120 for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

In particular embodiments, one or more data storages 140 may be communicatively linked to one or more servers 120. In particular embodiments, data storages 140 may be used to store various types of information. In particular embodiments, the information stored in data storages 140 may be organized according to specific data structures. In particular embodiments, each data storage 140 may be a relational database. Particular embodiments may provide interfaces that enable servers 120 or clients 130 to manage, e.g., retrieve, modify, add, or delete, the information stored in data storage 140.

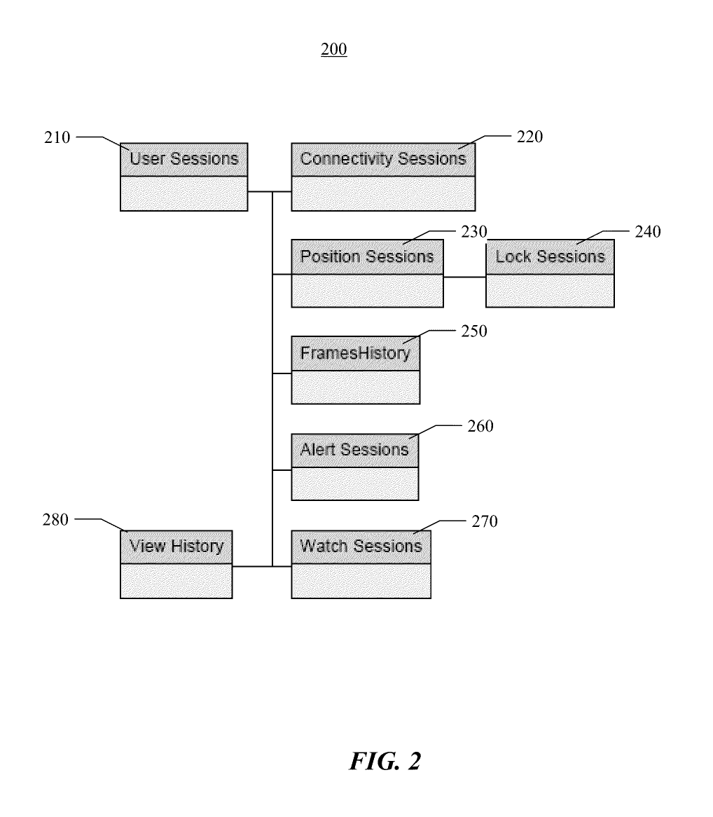

FIG. 2 illustrates an example session hierarchy 200. In particular embodiments, user sessions 210 may include information associated with activity from the time the user uses a client device. In the example of FIG. 2, a user session 210 may include a connectivity session 220, a position session 230, GPS lock sessions 240, Frame history or transmit sessions 250, or any combination thereof. In particular embodiments, user sessions 210 may include information that links data included in the other sub-sessions and records the particular time period a client device is used or the time that the client device last posted a status update prior to another sign-on event. In particular embodiments, connectivity sessions 220 may include information associated with particular periods of time in which the client device maintained regular communication with the vision server. For particular devices that do not maintain constant and/or regular communication, such devices may periodically reconnect a connectivity session. In particular embodiments, position sessions 230 includes information that starts from a particular time a user turns on the GPS device of the client device until the GPS device is turned off. Moreover, multiple position sessions 230 may exist in cases where the user manually toggles the active state of their GPS.

In particular embodiments, a lock session 240 may be generated each time a client device initially gains a lock. If the lock is reported as lost, the mapping service may close the lock session 240. In particular embodiments, each transmission from a client device may be recorded in a frames history session 250. In particular embodiments, alert sessions 260 may include information associated with the length of time that alert mode is activated on the client device. In particular embodiments, watch sessions 270 may include information associated with when a user starts viewing streaming content captured by a video device. As an example and not by way of limitation, the streaming content may be captured from another client device, a screencast, an external camera configured in a camera catalog, or any combination thereof. As another example, a watch session 270 may be created to track the period of time a user is watching at least one transmission. In particular embodiments, a watch session 270 may include two or more streams of content. In particular embodiments, sessions which overlap in time may be presented as a single session, or may be individually selectable. In particular embodiments, view history session 280 may include historical information about streaming content viewed by a user.

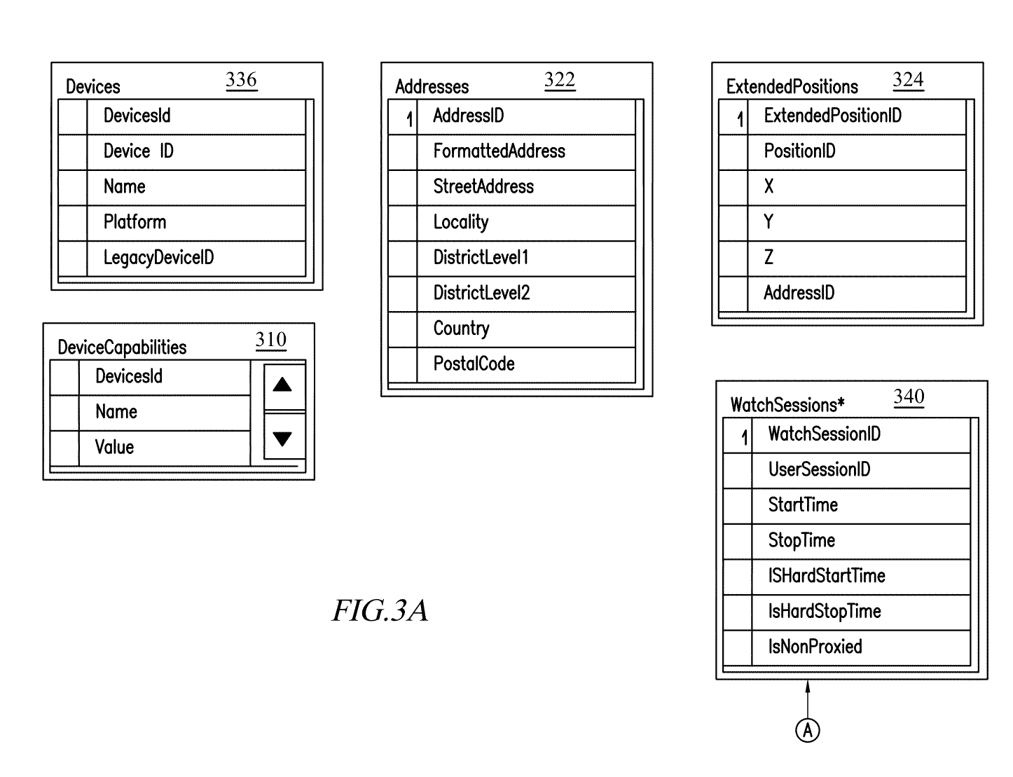

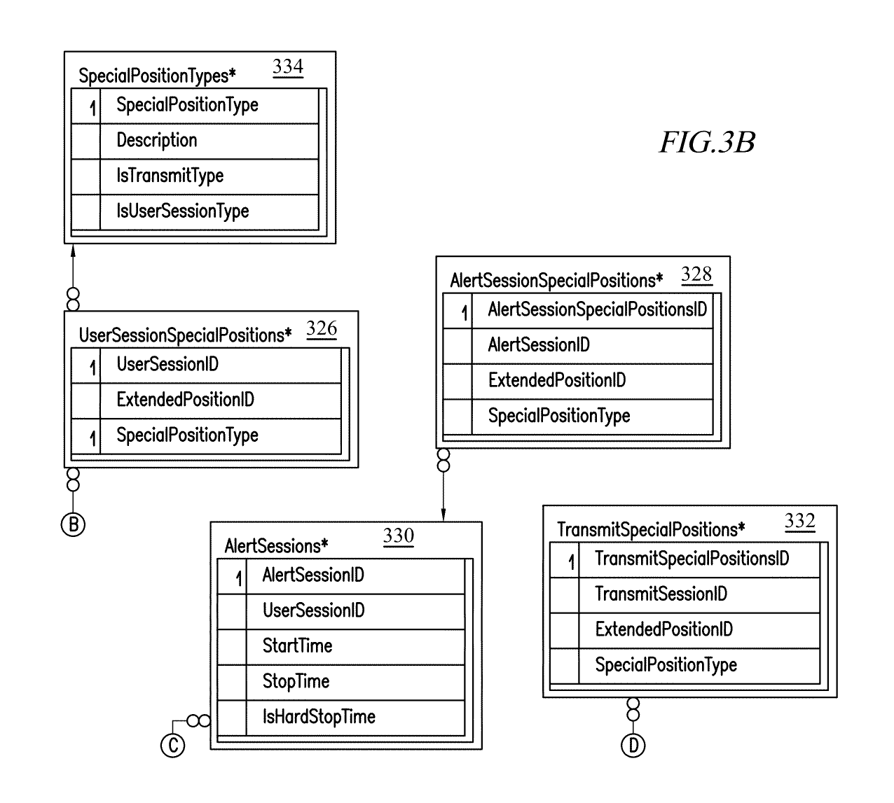

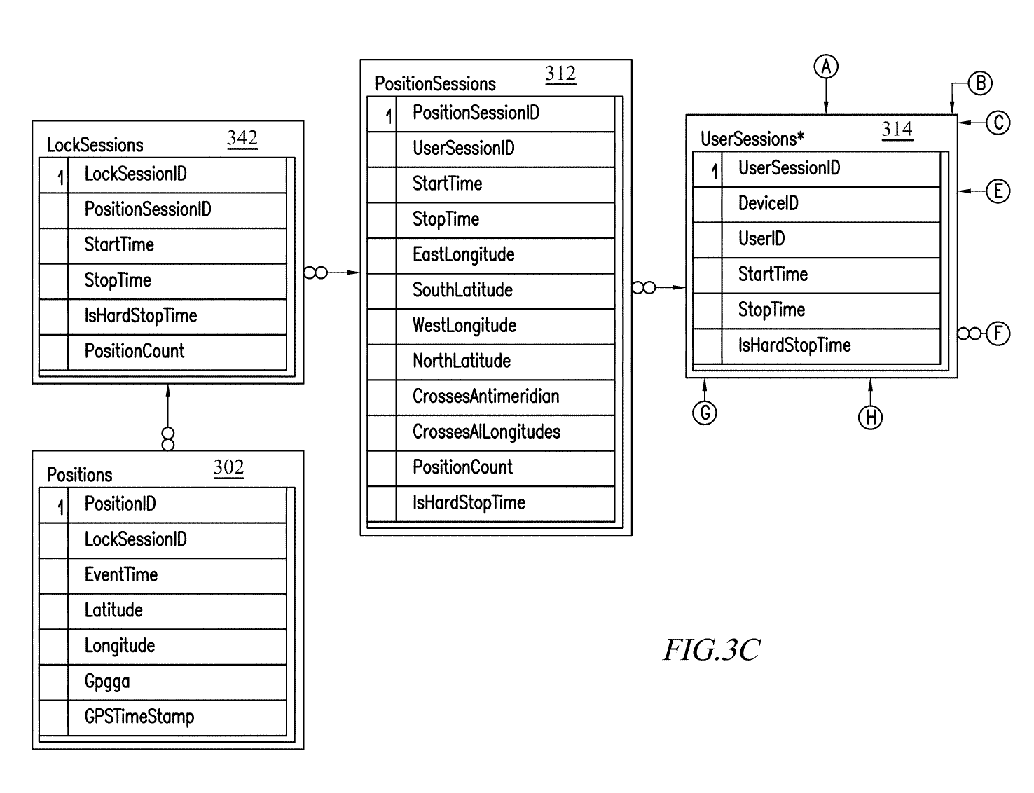

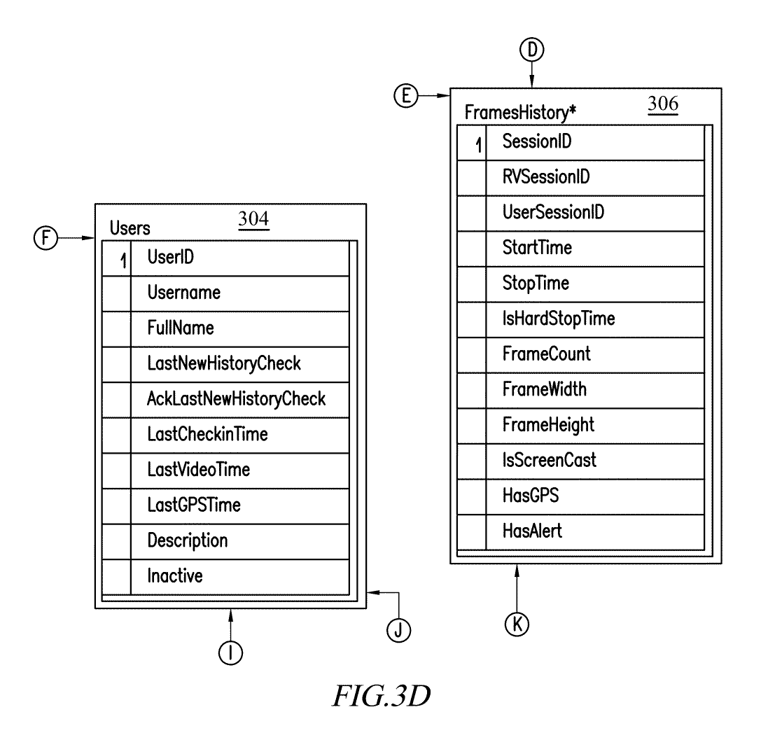

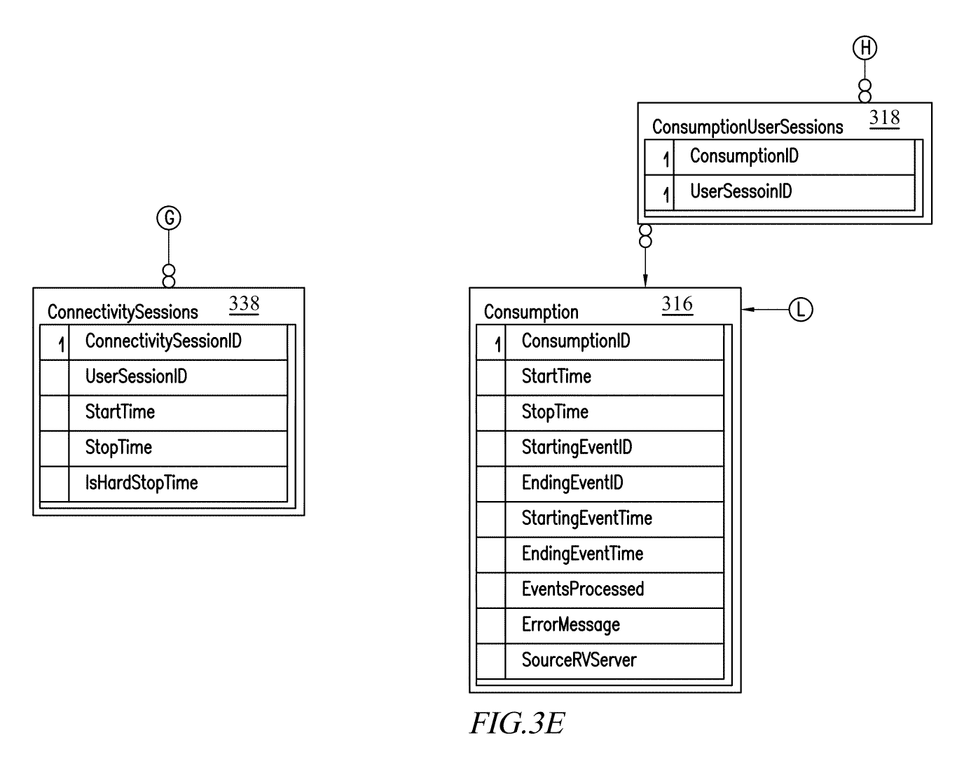

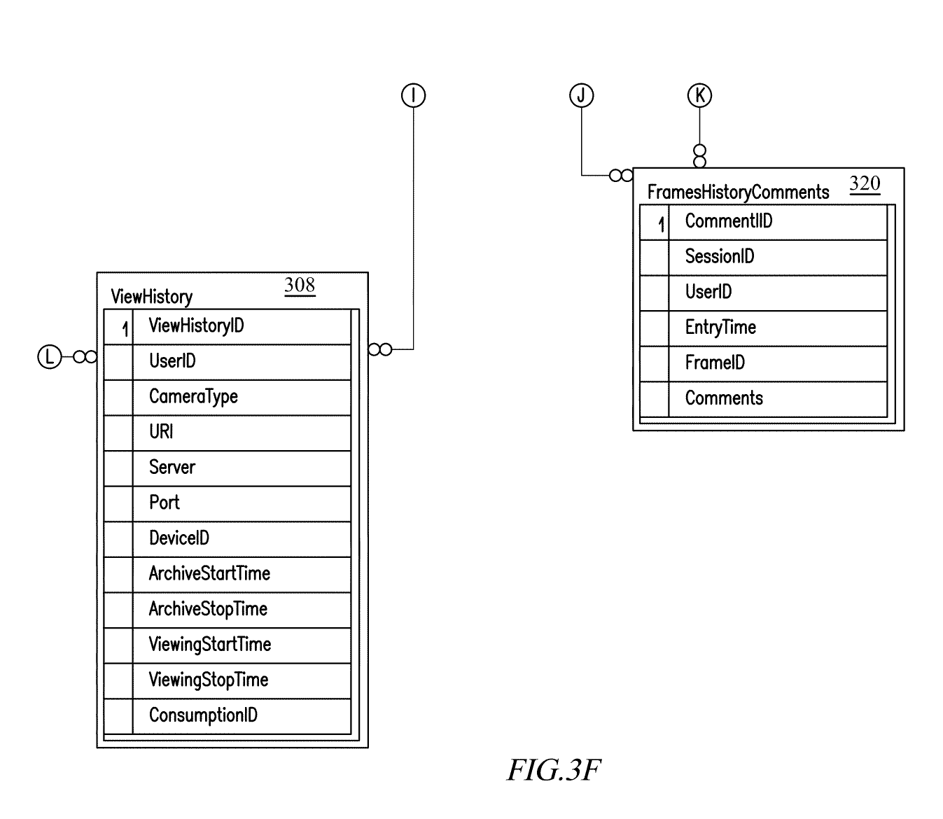

FIG. 3 illustrates an example database schema for a session hierarchy as described in FIG. 2. In particular embodiments, one or more logs may be stored in one or more database tables. In particular embodiments, a session may correspond to one or more logs and/or tables, and a log and/or table may be used by one or more types of sessions. The session manager upon a new mapping process, accesses a list of open user sessions 210 still open as of the completion of the last mapping process and load open user sessions 210 into memory. In particular embodiments, a source log may include status updates (e.g., as moments in time), position data for a user, or any other logged information. Each record in the source log may include data from the prior status report as well as the current status change.

Positions table(s) 302 may include information associated with the location of a client device. As an example and not by way of limitation, position table(s) 302 may include information corresponding to each GPS position reported to the vision server. Based on the statuses and the types of events, the other tables are queried and examined to fill in the remaining data needed to complete the user session, as described below. As an example and not by way of limitation, the source log data corresponding to the latitude and longitude may be repeated with every row even when the latitude and longitude have not changed. In particular embodiments, the location information from the source log data may be mapped to a single row in positions table(s) 302. In fact, a user session 210 may contain one or more sub-sessions. As an example and not by way of limitation, a user using a device gains a lock but then moves into a region with no connectivity. They then transmit a scene of interest, and then later transmit a second scene before logging off. In this scenario there would be a single user session with two connectivity sessions and two transmit sessions. It might also contain a position and lock session if a GPS lock was obtained.

Users table(s) 304 may include linkage information to provide the user logon identification (ID) or the user's full name if captured during processing of data or manually entered by the user. In particular embodiments, frames history log table(s) 306 may contain data corresponding to streaming content a user accessed through the “vision” server. The “analytics” server may perform an examination of user session 210 and may add additional metadata for future retrieval, such as for example whether the user session 210 was associated with an alert. A viewers log may be a temporary table that may include information of streaming content being viewed at the time the mapping process is being performed. The viewers log in conjunction with view history log table(s) 308 may provide the analytic server a capability of substantially simultaneously displaying streaming content in real-time and archiving data when the analytic server to continuously accesses data stored on the vision database. In particular embodiments, a device capabilities log 310 may include the metadata reported by the client devices associated with the user. As an example and not by way of limitation, information of device capabilities log 310 may include characteristics of each device, the OS of the device, memory size, device manufacturer, or any combination thereof.

One or more user session tables 314 may be associated with user session 210. Consumption table(s) 316 may include information associated with the last time the mapping process is completed so that the mapping process may resume at the stopping point of the previous mapping process. Consumption user session table(s) 318 may include information to associate user sessions 210 with a specific analytic server. As an example and not by way of limitation, a consumption user session may allow the analytic servers to access data from multiple vision servers and differentiate between the vision servers when connecting to access additional data. In particular embodiments, frames history comments table(s) 320 may be a copy of the frames history comments table from the vision database. In particular embodiments, linkage between frames history table(s) 320 is maintained and the frames within the transmission they are linked to are also maintained. Addresses table(s) 322 may include address data from a configured GIS support software, such as for example Bing Maps, Google Maps, etc. In particular embodiments, the mapping process may attempt a single query for a given location's address and stores the details about that address in addresses table(s) 322.

In particular embodiments, extended positions table(s) 324 may include information associated with a specific geographic location. As an example and not by way of limitation, if other locations are added in the same location, a reference to this location is used rather than duplicating the location data. Extended position table(s) 324 may reference a specific addresses table(s) 322 entry for a description of where that location is. User session special positions table(s) 326 may be a reference table that creates a linkage from the user sessions table(s) 314 to the address information through extended positions table(s) 324. Alert session special positions table(s) 328 may be a reference table to create a linkage from alert session table(s) 330 to the address information though extended positions table(s) 324. In particular embodiments, transmit special positions table(s) 332 may be a reference table to create a linkage from the frames history log table(s) 306 to the address information through the extended positions table(s) 324. In particular embodiments, special positions types table(s) 334 may include one or more types of special positions. Each special position captured for a user, transmit or alert session has a specific type associated with it. Depending on the type of session, the expected values can vary from first to last position, farthest position from the first position, etc. In particular embodiments, users table(s) 304 may include information about a user and is cross-referenced by user session table(s) 314 for determination of the particular user associated with the particular user session 210.

In particular embodiments, devices table(s) 336 may include top-level device information associated with client devices that associated with the vision server. In particular embodiments, device capabilities table(s) 310 may include data associated with the client devices. As an example and not by way of limitation, each client device may have row in device capabilities table(s) 310. As another example, a new device with a new capability may be added without requiring the modification of all other client devices listed in device capabilities table(s) 310. In particular embodiments, each device capability may be linked back to a single device in devices table(s) 336. In particular embodiments, each piece of data about a device may be broken out into its own row within this table. This allows devices to record different data within the table when a new device with a new capability is added to the system without necessarily requiring the modification of other devices. Each capability may be linked back to a single device in the devices table(s) 336. Knowledge of the OS and type of device may help to properly process the event stream from the source log.

In particular embodiments, client devices, such as for example Android, iPhone, Windows Mobile, or any combination thereof may only watch a single feed at a give time. In other particular embodiments, other client devices may be configured to view multiple feeds simultaneously. Under these circumstances, only a single watch session 270 is created. Viewer history table(s) 308 may include data associated with streaming content a particular user is viewing. In some embodiments, this may be a sub-session of Watch Sessions. In particular embodiments, the mapping process may query a global information system (GIS) service for known addresses for the locations stored in positions table(s) 302. These addresses when received are posted to addresses table(s) 322 for reference during primary processing of the analytic server.

In particular embodiments, a type of status change for user session 210 may be checked in response to accessing the source log. In particular embodiments, when a status update is received, the mapping service may update its connectivity sessions table(s) 338 and pass the event on for evaluation for updates to the alert session table(s) 330 and watch session table(s) 340 as well. In particular embodiments, when accessing each of these sessions a new session may be created or an existing session updated if one is currently open. As an example and not by way of limitation, when a source log is evaluated with respect to connectivity session 220, a determination is made as to whether a time of the particular source log is greater than 3 minutes from the current value of the connectivity session's 220 stop time. If it is, that indicates a break in connectivity and the existing connectivity session 220 is closed and a new connectivity session 220 may be created with the new time as the start and stop times for the new connectivity session 220. In particular embodiments, this does not affect any other open sub-sessions since, as an example, a user could leave watch or alert active during a period where cell tower coverage is not available while the user waits for it to return. So loss of connectivity is not considered in detecting changes to other sub-session state changes. In particular embodiments, a determination may be made with respect to watch 270 and alert sessions 260 as to whether a change in their status state has occurred. If there is an open session and the new source log has a watch or alert flag cleared, the open session is closed. If the flag is set and a session is currently open, its stop time is updated. If a status flag is set and there is no session open, a new one is created. When the flag is clear and no session exists, the flag is ignored and the mapping processing continues.

In particular embodiments, when a position update is received, it is checked for changes in lock status as well as position changes. Similar to watch and alert, changes to the lock status are monitored and upon changes in status the open lock sessions 240 are closed or new ones created. In particular embodiments, changes in GPS activation close, update or create new position sessions 230. Within the open lock session table(s) 342, the new locations may be linked for storage during the write phase in positions reference table(s). In particular updates, position updates may also update connectivity session table(s) 338, as described above. In particular embodiments, each command request is checked against the connectivity sessions 220, as described above. Since no other states change during a request for new commands to a device, the record doesn't require processing by other session types.

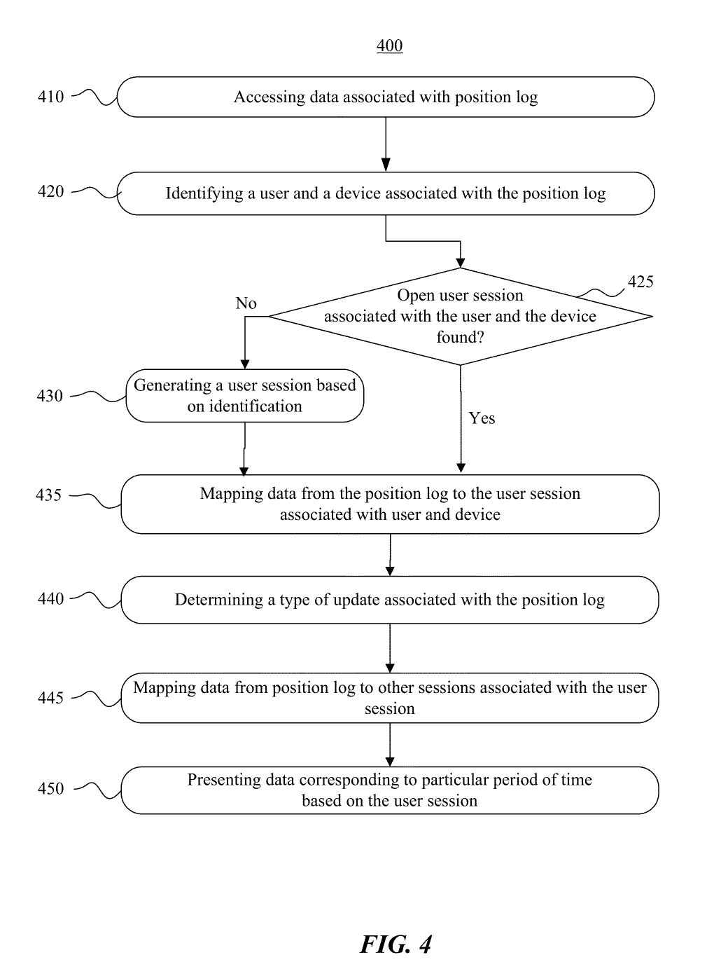

FIG. 4 illustrates an example method 400 for presenting data corresponding to a particular period of time. The process of “consumption” of the raw data may be used in order to generate various session types, at least in part.

At step 410, data associated with one or more source logs is accessed. In particular embodiments, data associated with the source logs may include streaming content or geographic data. As an example and not by way of limitation, streaming content may include video and audio data.

At step 420, a user and device associated with at least one source log may be identified. In particular embodiments, entries in the same and/or other source logs may be examined to locate data records associated with the user and/or the device. Data from the source log(s) associated with the user and/or the device may be retrieved; in particular embodiments, data is retrieved for the combination of the user with the device.

In particular embodiments, at step 425, a determination is made as to whether an open user session associated with the identified user and device exists. If an open user session does exist, then the method may proceed to step 435. If no open user session exists, at step 430, a new user session is generated based at least in part on the identification of the user and device.

At step 435, data may be mapped from the source log(s) to the new user session associated with the user and the device. In particular embodiments, this step comprises storing data from the source log(s) to database tables associated with the user session, and possibly other session types as well.

In particular embodiments, at step 440, a type of update associated with one or more particular source log entries may be determined: a status update, a position update, a command request, or any combination thereof. Data in the user session may be updated based on the type of status change. In particular embodiments, step 445 maps data associated with the source log(s) to one or more other sessions associated with the user session.

At step 450, data corresponding to a particular period of time based on the user session is presented. In particular embodiments, the data may include geographic data and streaming content. As discussed above, the streaming content may include video data, audio data, or a combination thereof.

Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components carrying out particular steps of the method of FIG. 4, this disclosure contemplates any suitable combination of any suitable components carrying out any suitable steps of the method of FIG. 4.

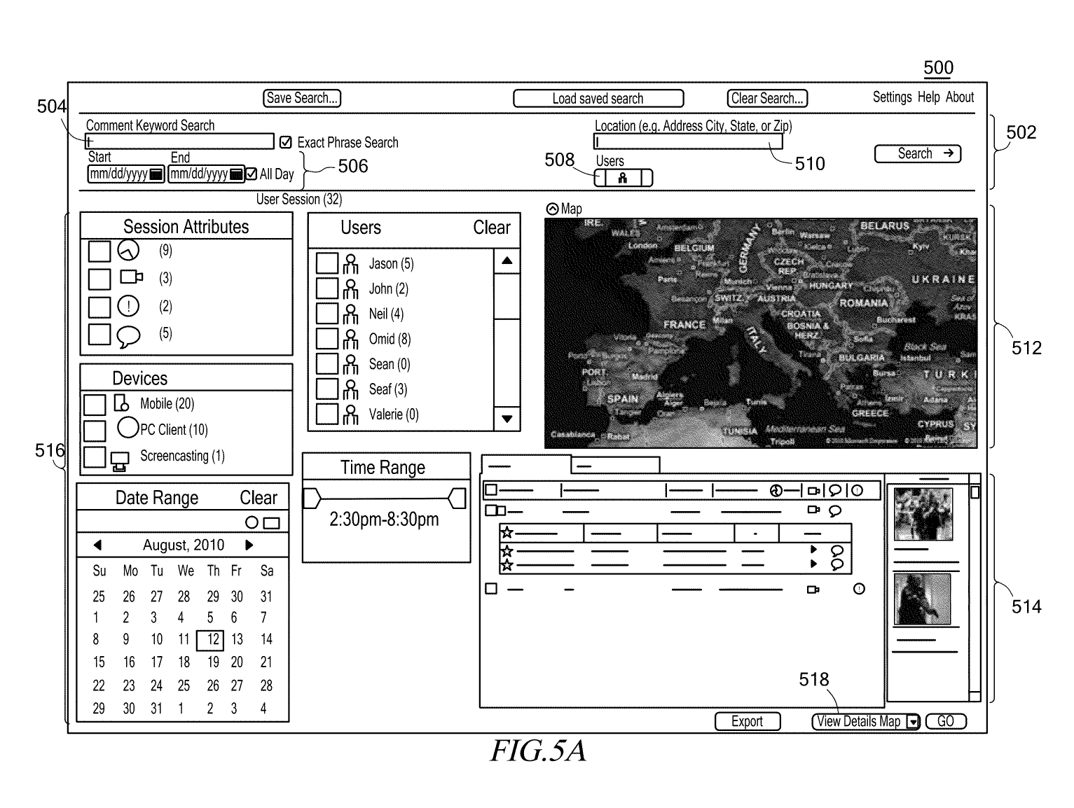

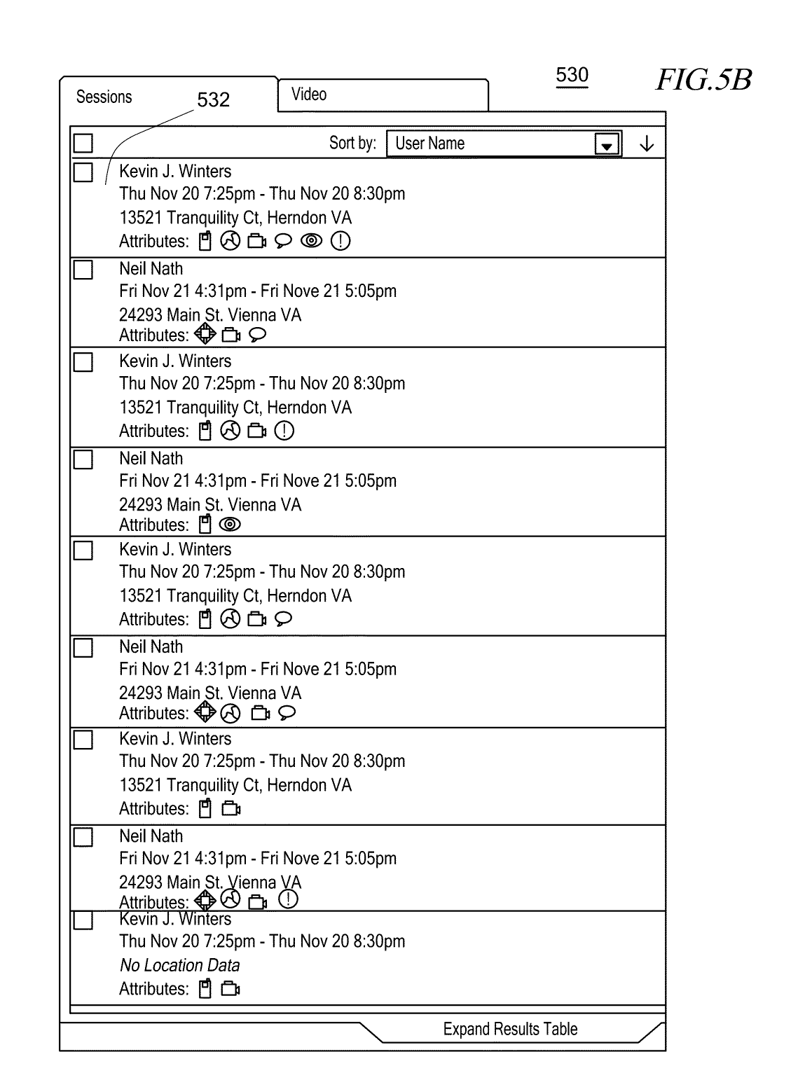

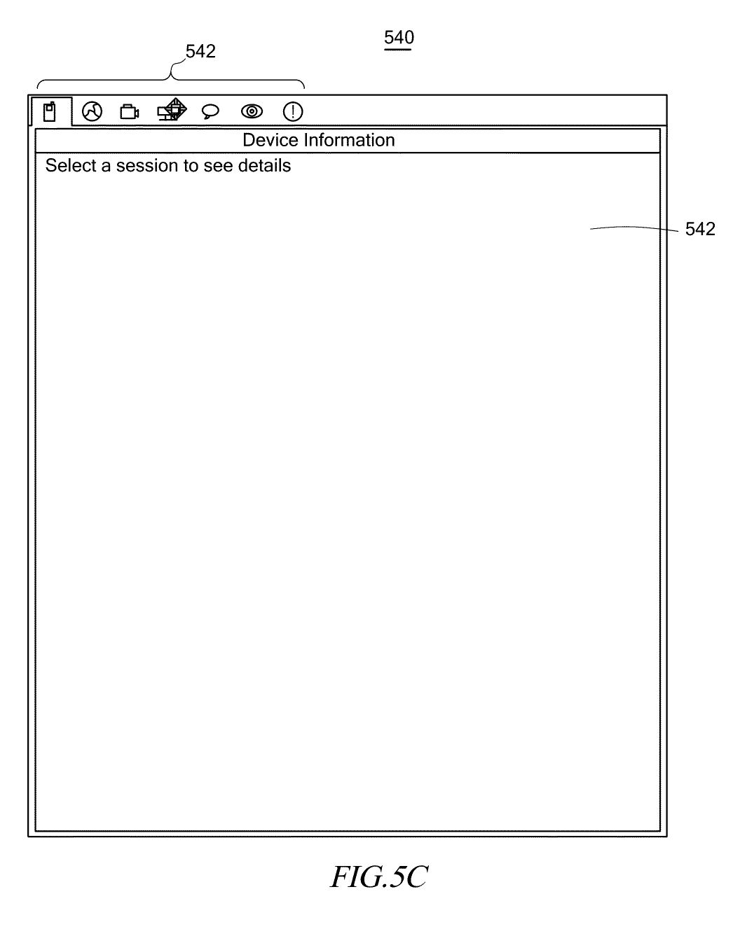

FIG. 5A illustrates an example analytic search page. In particular embodiments, a user may search the stored data associated with each user session through example analytic search page 500. Although this disclosure illustrates and describes inputting various search parameters using particular graphical user interface (GUI) components, this disclosure contemplates any suitable GUI component such as for example, text boxes, check boxes, drop-down lists, list boxes, combo boxes, radio buttons, or pop-up components. Moreover, this disclosure describes and illustrates a particular search page having a particular implementation with particular GUI components, this disclosure contemplates any suitable search page having any suitable implementation with any suitable GUI components.

As discussed above, searchable data associated with a user session may comprise video, connection start/end times, GPS, transmit, comments, commands, alerts, images, or a time stamp. One or more search parameters that serve to filter the results of the search of the analytic data may be entered in search parameter area 502. Particular embodiments may enable an operator to refine a search based on one or more fields specified in example analytic search page 500. In particular embodiments, a keyword of comments stored in the COMMENTS session of the user session may be entered by a user in keyword search text box 504. As an example and not by way of limitation, a search of comments associated with a video session may be performed of the data of COMMENTS session based on the text provided in keyword search text box 504. As another example, a search of comments associated with a video frame may be performed of the data of COMMENTS session based on the text provided in keyword search text box 504. The text entered in keyword search text box 504 may be used as a search criterion comprising a set of individual words. In particular embodiments, a search performed through keyword search area 504 may be implemented as a FREETEXT query from a SQL full text search. In particular embodiments, the text entered in keyword search text box 504 may be used as a phrasal search criterion instead of search criterion based on a set of individual key words.

In particular embodiments, may enable a user to search for streaming content based on a particular date or a particular time of the particular day. As an example, data corresponding to a start and end date of a particular period of time may be entered in combo boxes 506 of example search page 500. As another example, a start and end date search criterion may be input using a drop-down calendar on example search page 500. In particular embodiments, a search of data associated with a particular day may include the data for the entire day. In particular embodiments, the search of data associated with the user session may be refined for a particular start or end time of a particular day. As an example and not by way of limitation, the user may toggle between a search of data associated with an entirety of a particular day or specifying a particular start or end time within a particular day using a check box. As another example, one or more pull-down menus configured to refine a search to a particular start or end time may appear in response to removing a checkmark in the check box.

In particular embodiments, the user may perform a search for data related to a particular user through example search page 500. As an example and not by way of limitation, one or more drop-down menus configured to select one or more particular users as a search criterion may appear in response to clicking user button 508. In particular embodiments, clicking user button 508 may drop down two side-by-side menus with one or more directional arrow icons in between the menus to move one or more names of users from one menu to the other. As an example and not by way of limitation, a list box populated with name of users adjacent to a drop-down list may appear in response to clicking user button 508. Moreover, names from the list box may be transferred between the list box and drop-down list through directional arrows located between the list box and drop-down list. In particular embodiments, the user name associated with a particular user may be shown in a tooltip in response to a cursor hovering over a particular user.

In particular embodiments, the user may perform a search of data related to a particular geo-location through example search page 500. As an example and not by way of limitation, an indicator may be overlaid on an illustration of a map 512 that includes the location where data associated with a particular user session in response to searching a particular geo-location. In particular embodiments, the user session accessed as a location-based search result may be identified using an indicator of any suitable shape or color that is overlaid on map 512. In particular embodiments, a location text box 510 may be configured to receive textual input corresponding to the particular location for use as a search criterion. In particular embodiments, search results for a particular user session may be refined through selecting a particular region of map 512. As an example and not by way of limitation, selecting one or more regions of map 512 using a cursor may be configured to refine a location-based search. As another example, map 512 may automatically focus or zoom in on a particular region of map 512 based at least in part on the returned search results. In particular embodiments, map 512 may display a region with a maximum amount of detail or resolution that includes the locations of returned search results.

In the example of FIG. 5A, search results of the user session may be displayed in search result area 514 of example search page 500. As an example and not by way of limitation, the search results may be listed according by user session. In particular embodiments, the search results may be listed in rows with one or more parameters associated with the mapping described above. In particular embodiments, the list of search results displayed in search result area 514 may be sort enabled though the one or more parameters. As an example and not by way of limitation, the parameter in each column may be sort enabled by clicking on a column header. As another example, the order of the sorting of the data in each column may be inverted by clicking on the column header. In particular embodiments, the default sort may be alphabetical. As an example and not by way of limitation, a default sort of search results may be alphabetical by username. Although this disclosure describes listing and sorting search results according to particular parameters, this disclosure contemplates listing or sorting search results according to any suitable parameters, such as for example, comments, date, users, or location.

In particular embodiments, the returned search results may include a location of a user session. As an example and not by way of limitation, information corresponding to the location of the user session may be a first position point recorded during a user session. As another example, the information corresponding to the location may be generated by a GIS application that maps GIS coordinates to a geo-location. In particular embodiments, the data associated with the search results may be expanded to display data associated with streaming content associated with the user sessions. As an example and not by way of limitation, an icon may be clicked to expand or collapse the details associated with streaming content associated with the user sessions. As another example, data associated with the streaming data may include date or time, duration, location, or comments. In particular embodiments, the search results may include an icon that initiates playback of the steaming content.

In particular embodiments, example search page 500 may include a filter area 516 with one or more portions to select one or more search criteria. As an example and not by way of limitation, filter areas 516 may be based on location, session attributes, users, device types, date range, time range, or any combination thereof. In particular embodiments, search criterion selected using one or more filter areas 516 may be logically combined. As an example and not by way of limitation, selecting two or more search criteria within a filter area 516 may perform a logical “OR” of their attributes. As another example, selecting search criteria between two or more filter areas 516 may perform a logical “AND” of their attributes. In particular embodiments, session attributes may include location, video, alert, comments, or a combination thereof. In particular embodiments, a portion of filter area 516 may include a list of names of users selected in a search query. In particular embodiments, a portion of the filter area 516 associated with device types may include mobile, personal computer (PC), screencasting devices, or any combination thereof.

In particular embodiments, the date range may be specified using a calendar view in a portion of filter area 516. In other particular embodiments, a title for months matching the search results may be displayed in a tree view. As an example and not by way of limitation, the portion of filter area 516 associated with a date range may include one or more icons to toggle between the calendar and tree views. As another example, clicking on a month listed in the tree view may toggle to the calendar view showing the specified month. In particular embodiments, a time range may be selected through a portion of filter area 516. In particular embodiments, map 512 may be updated to display user sessions matching search criteria selected in the filter area 516. In particular embodiments, a drop-down box 518 may provide a list of options for viewing user sessions selected in search result area 514. In particular embodiments, search results may be shared with other users. As an example and not by way of limitation, a unique uniform resource locator (URL) corresponding to the returned search results may be generated and sent to other users.

FIG. 5B illustrates an example display of user session in an example search page. In particular embodiments, the returned search results may be presented using a results table 530 of the search results. In particular embodiments, data associated with one or more user sessions 532 may be displayed in example results table 530. As an example and not by way of limitation, data associated with the user sessions 532 may include user identification, start or end time, location, attributes, or any combination thereof. Moreover, attributes associated with the user sessions 532 may be mapped to one or more icons and clicking on the icons may display data associated with the particular attribute, as described below.

FIG. 5C illustrates an example attributes panel in an example search page. In particular embodiments, a user may examine detailed information associated with selected user sessions through an example attributes panel 540. In particular embodiments, attributes associated with user sessions may include device, location, frame history or transmit, screencast sessions, comments, watch sessions, alert sessions, or any combination thereof. As an example and not by way of limitation, icons 542 corresponding to each attribute may be displayed on example attributes panel 540. As another example, clicking a particular icon may display data associated with the particular attribute in data area 544. In particular embodiments, data associated with a device attribute may include a device name, operating system (OS), platform, application version, phone support, phone number, GPS support, video support, receive commands, or any combination thereof. In particular embodiments, data associated with the location attribute may include a map, further points traveled, start or end location, start or end coordinates, or any combination thereof. In particular embodiments, data associated with video session attribute may include a thumbnail, or a date, time, comments, or alert associated with the particular streaming content, or any combination thereof. In particular embodiments, a cursor hovering over the watch session of a particular streaming content may initiate a fly-out. As an example and not by way of limitation, contents of the fly-out may be based at least in part on a type of video source watched by the user during a watch session.

FIG. 5D illustrates an example analytic visual search page. In particular embodiments, the returned search results may be presented using a visual view 520 of the search results according to the streaming content associated with the particular user sessions. As an example and not by way of limitation, the example visual view 520 may display a thumbnail 522 image that corresponds to streaming content associated with each user session that is associated with the search results. As another example, thumbnails 522 may be displayed chronologically in the example visual view 520 from left to right. In particular embodiments, individual streaming content may be selected for further analysis. In particular embodiments, one or more thumbnails 522 may have associated data. As an example and not by way of limitation, the data associated with thumbnails 522 may include a user name, date, start time, duration, location, or any combination thereof associated with the streaming content.

In particular embodiments, an analytics video player, described below, may open as a fly-out and initiate playback of selected streaming content. In particular embodiments, a particular frame of video streaming content may be selected using the analytics video player. As an example and not by way of limitation, the analytics video player may be paused to display the selected frame of streaming content. As another example, if there is no comment associated with particular streaming content, a frame corresponding to approximately a middle of the streaming content may be used as thumbnail 522. In particular embodiments, a search may be performed on comments associated with frames matching a search criterion. As an example and not by way of limitation, frames of the streaming content matching the search criterion may be displayed under each streaming content. In particular embodiments, clicking on a particular thumbnail 522 may initiate a display of one or more related frames with comments for particular streaming content in display area 524. As an example and not by way of limitation, a thumbnail 522 for each frame for one or more comments that matches a search criterion may be displayed. As another example, a time associated with the displayed thumbnail 522 may be displayed with the thumbnail 522.

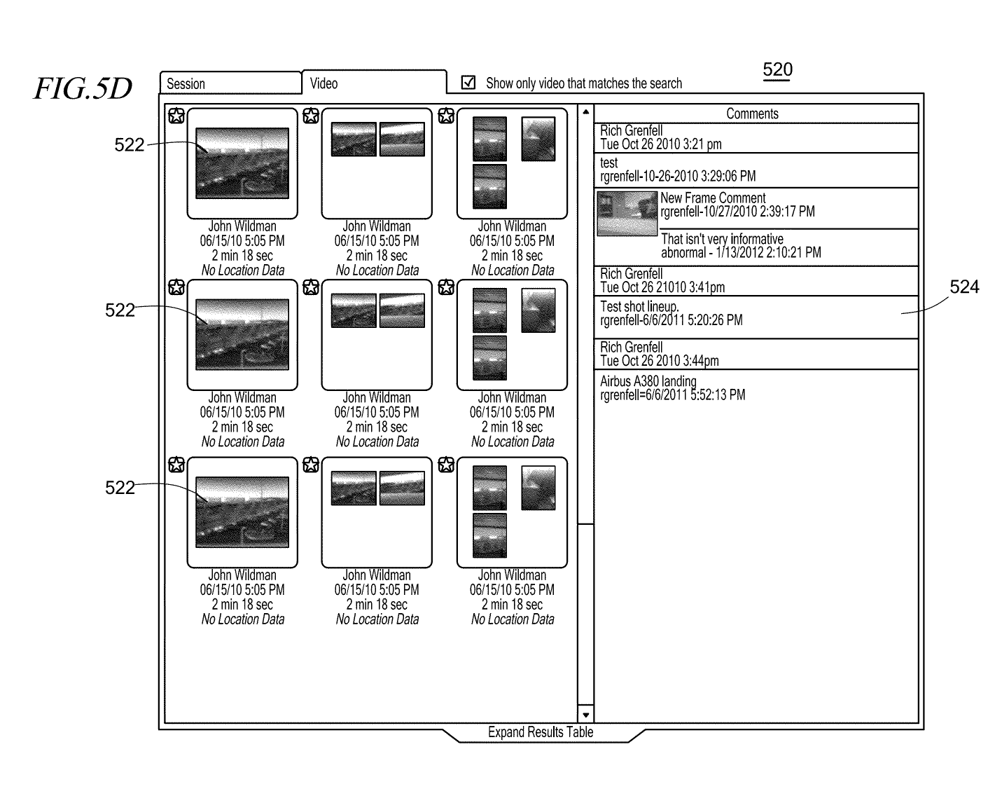

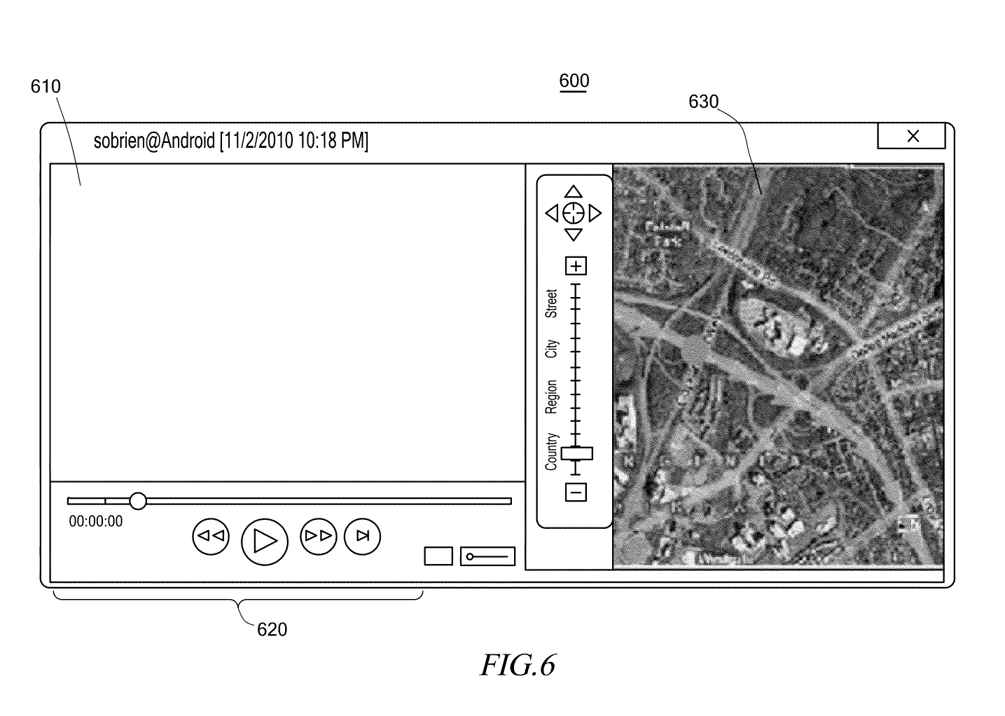

FIG. 6 illustrates an example analytic video player. In particular embodiments, streaming content corresponding to a particular period of time may be displayed using example analytic video player 600. In particular embodiments, streaming content for playback may be stored on a server. As described above, streaming content may include video and audio data. As an example and not by way of limitation, example analytic video player 600 may include a viewing area 610 and playback controls 620. As another example, playback controls 620 may include a play/pause button, step forward, jump forward, jump backward, or any combination thereof. In particular embodiments, the play and pause functions may be a single button that toggles between the two functions. In particular embodiments, the play function may initiate playback from a frame displayed in display area 610. In particular embodiments, the jump forward button may advance the streaming content by a pre-determined amount of time. Similarly, the jump backward button move the streaming content back by a pre-determined amount of time. In particular embodiments, playback controls 620 may include a slider that moves playback of the streaming content to a particular point in time.

In particular embodiments, example analytic video player 600 may include an information window 630. As an example and not by way of limitation, information window 630 may be displayed through clicking a button when the particular streaming content has associated GPS data. In particular embodiments, markers may be displayed that correspond to GPS data points. In particular embodiments, the map displayed in information window 630 may display an indicator corresponding to the movement of the user in accordance with the position data in the position log. As an example and not by way of limitation, playback of the streaming content may be moved to a particular position of the streaming content by clicking a corresponding marker. In particular embodiments, information window 630 may include pan controls that may allow movement of the map displayed in information window 630. In particular embodiments, one or more comments associated with frames of particular streaming data may be displayed in information window 630. As an example and not by way of limitation, comments associated with frames of particular streaming data may be displayed in response to clicking a particular button. As another example, the comments may include a thumbnail associated with the streaming data. Moreover, clicking the thumbnail associated with a particular comment may display the streaming content in display area 610 starting at the frame corresponding to the displayed thumbnail.

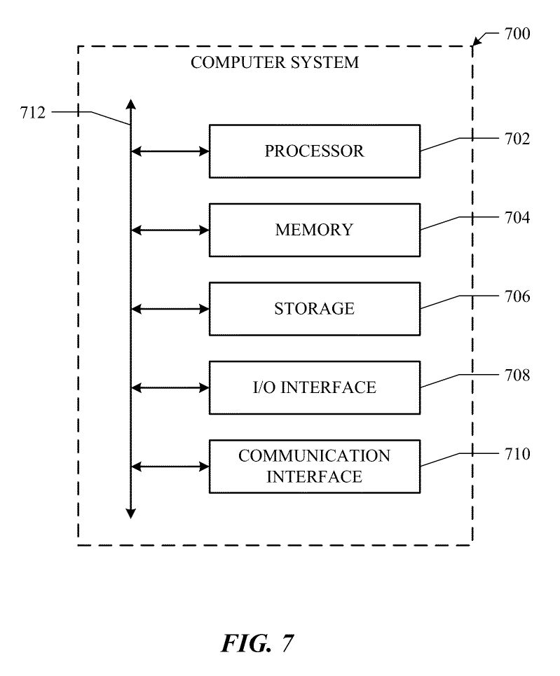

FIG. 7 illustrates example computing system. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 78 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, r component is so adapted, arranged, capable, configured, enabled, operable, or operative.

What is claimed is:

1. A method comprising:
accessing, by one or more processors associated with one or more computer servers, data associated with one or more source logs, the data associated with the one or more source logs corresponding to activity of a user at one or more times;
identifying, by the one or more processors, the user and a device associated with the one or more source logs;
mapping, by the one or more processors, at least a portion of the data associated with the one or more source logs to a user session associated with the user and the device, the user session corresponding to activity of the user while using the device; and
providing, by the one or more processors, data corresponding to a particular period of time based on the user session, wherein the data corresponding to the particular period of time comprises streaming content and geographic data captured during the particular period of time.

2. The method of claim 1, wherein the streaming content comprises video data, audio data, or any combination thereof.

3. The method of claim 1, further comprising generating a new user session for the user based at least in part on whether the user has an existing user session.

4. The method of claim 1, wherein the user session comprises one or more sub-sessions, each sub-session comprising information about connectivity, position, frames history, alert, watch, or any combination thereof, the sub-sessions being associated with time, position, or transmission data of the one or more source logs.

5. The method of claim 4, further comprising:
determining a type of status change associated with the one or more source logs; and
updating data contained in one or more of the sub-sessions of the user session based on the type of the status change.

6. The method of claim 5, wherein the type of status change comprises a status update, a position update, a command request, or any combination thereof.

7. The method of claim 6, further comprising updating data associated with a connectivity sub-session of the user session in response to detecting the status update.

8. The method of claim 6, further comprising updating a position sub-session of the user session in response to detecting the position update.

9. The method of claim 4, further comprising mapping data from the one or more source logs to one or more of the sub-sessions based at least in part on the type of the status change associated with the one or more source logs.

10. The method of claim 9, further comprising mapping at least a portion of data from a viewers log and a view history log to a view history sub-session.

11. The method of claim 4, wherein a connectivity sub-session of the user session comprises data corresponding to a period of time the device is in communication with a server.

12. The method of claim 1, further comprising:
indicating whether the user session remains open after completing the provision of the data; and
loading into memory the open user session in response to re-accessing the one or more source logs.

13. The method of claim 1, wherein the one or more source logs comprise data associated with a prior status report and a current status change.

14. The method of claim 1, wherein the accessing of the one or more source logs is performed in accordance to a pre-determined schedule.

15. The method of claim 1, wherein the accessing of the one or more source logs is performed in response to receiving data associated with a status change.

16. The method of claim 1, further comprising querying a geographic information system (GIS) service for an address corresponding to one or more locations corresponding to information in the one or more source logs.

17. The method of claim 1, wherein the one or more source logs further comprise global positioning system (GPS) data.

18. The method of claim 1, further comprising storing the user session in a database that is separate from the one or more source logs.

19. One or more computer-readable non-transitory storage media embodying software to:
access data associated with one or more source logs, the data associated with the one or more source logs corresponding to activity of a user at one or more times;
identify the user and a device associated with the one or more source logs;
map at least a portion of the data associated with the one or more source logs to a user session associated with the user and the device, the user session corresponding to activity of the user while using the device; and
provide data corresponding to a particular period of time based on the user session, wherein the data corresponding to the particular period of time comprises streaming content and geographic data captured during the particular period of time.

20. A device comprising:
a processor; and
one or more computer-readable non-transitory storage media coupled to the processor and embodying software to:
access data associated with one or more source logs, the data associated with the one or more source logs corresponding to activity of a user at one or more times;
identify the user and a device associated with the one or more source logs;
map at least a portion of the data associated with the one or more source logs to a user session associated with the user and the device, the user session corresponding to activity of the user while using the device; and
provide data corresponding to a particular period of time based on the user session, wherein the data corresponding to the particular period of time comprises streaming content and geographic data captured during the particular period of time.
